(19) United States
(12) Patent Application Publication
(10) Pub. No.: US 2021/0009417 A1
(43) Pub. Date: Jan. 14, 2021

(54) PRODUCTION DEVICE AND PRODUCTION METHOD OF ELECTRONIC GRADE HYDROGEN PEROXIDE AQUEOUS SOLUTION

(71) Applicant: Beijing University of Chemical Technology, Beijing (CN)

(72) Inventor: Qunsheng LI, Beijing (CN)

(73) Assignee: Beijing University of Chemical Technology

(21) Appl. No.: 17/033,800

(22) Filed: Sep. 27, 2020

(30) Foreign Application Priority Data
Aug. 31, 2020 (CN) 2020108967780

(51) Int. Cl. C01B 15/013; C01B 15/017

(52) U.S. Cl. CPC C01B 15/0135; C01B 15/017

(57) ABSTRACT

Disclosed is a production device and production method of an electronic grade hydrogen peroxide aqueous solution. An industrial grade hydrogen peroxide is subjected to rectification, reverse osmosis, ion exchange, and finally filtered through an ultrafiltration membrane, and an electronic grade hydrogen peroxide aqueous solution is obtained. Through the above-mentioned integrated design, the disclosure overcomes the problems of small yield and low purity in the prior art, and the method for producing electronic grade hydrogen peroxide has low energy consumption, low cost and high profit, and is suitable for continuous mass production.

### TECHNICAL FIELD

The disclosure relates to the technical field of fine chemicals, and more specifically to a production device and production method of an electronic grade hydrogen peroxide aqueous solution.

### BACKGROUND

Hydrogen peroxide is an important green chemical raw material widely used in the bleaching of fabrics and pulp, chemical synthesis, wastewater treatment, aerospace propulsion and electronic industries. According to common application fields, hydrogen peroxide can be divided into industrial grade, reagent grade, pharmaceutical grade, food grade, electronic grade, propellant grade, etc. With the development of the electronics industry, the demand for electronic grade hydrogen peroxide as an, important cleaning agent and etchant is gradually increasing.

Since high purity electronic grade hydrogen peroxide directly affects the performance of integrated circuits and the continuity and stability of integrated circuits production, manufacturers are very cautious about the selection of the supply of high purity electronic grade hydrogen peroxide. However, the development of high purity electronic grade hydrogen peroxide industry in china is relatively late. The technology and service level of most domestic high purity electronic grade hydrogen peroxide companies still has a certain gap with well-known brands in countries outside of China. This has led to the market of high purity electronic grade hydrogen peroxide occupied by foreign brands for long term.

Electronic grade hydrogen peroxide aqueous solution is generally obtained by a series of refining and purification using industrial grade hydrogen peroxide aqueous solution as raw material. Common methods include distillation, adsorption, extraction, reverse osmosis membrane method, freezing crystallization method, resin method and ultrafiltration method. Using a single unit operation to purify the industrial hydrogen peroxide aqueous solution can improve the quality of the hydrogen peroxide aqueous solution but the single method has high energy consumption, high cost and low efficiency, and cannot meet the quality requirements of the electronic market for hydrogen peroxide products.

Therefore, providing a low cost, high efficiency, high purity, electronic grade hydrogen peroxide aqueous solution production method becomes an urgent problem for those skilled in the art.

### SUMMARY

For the reason above, the disclosure provides a production device and production method of electronic grade hydrogen peroxide aqueous solution. The production device and production method adopt multiple unit operations, optimizes integration of technologies, integrates the advantages of a single operation, and overcomes the disadvantages of high energy consumption, high production cost, and low purity.

In order to achieve the above objectives, the disclosure adopts the following technical solutions.

A production device of an electronic grade hydrogen peroxide aqueous solution is provided. The production device includes a rectification device, a first delivery pump, a reverse osmosis device, a second delivery pump, an ion exchange device, a third delivery pump, an ultrapure filter device, a fourth delivery pump and a filling device connected by pipelines in sequence.

Preferably the filling device is a nitrogen sealing device.

Preferably, the rectification device, the reverse osmosis device, the ultrapure filter device and the filling device are lined with HDPE layer.

Preferably, the ion exchange device, the first delivery pump, the second delivery pump, the third delivery pump and the fourth delivery pump are lined with PFA layer. A production method of the electronic grade hydrogen peroxide aqueous solution based on the above-mentioned production device is provided. The production method includes following steps.

(1) rectification: concentrating 27.5 wt % industrial grade hydrogen peroxide to 50 wt %˜70 wt % through rectification device;
(2) reverse osmosis: mixing the 50 wt %˜70 wt % hydrogen peroxide obtained in the step (1) with 50 wt % industrial grade hydrogen peroxide, pumping into the reverse osmosis device through the first delivery pump, and obtaining 31 wt % crude electronic grade hydrogen peroxide by reverse osmosis;
(3) ion exchange: transporting the 31 wt % crude electronic grade hydrogen peroxide obtained in step (2) to the ion exchange device through the second delivery pump, removing impurities through the ion exchange device and obtaining preliminary purified electronic grade hydrogen peroxide;
(4) ultrapure filtration: transporting the preliminary purified electronic grade hydrogen peroxide obtained in step (3) to the ultrapure filter device through the third delivery pump, obtaining 31 wt % electronic grade hydrogen peroxide by filtration, and transporting the 31 wt % electronic grade hydrogen peroxide to the filling device by the fourth delivery pump to store after filling.

Preferably, the 50 wt %˜70 wt % industrial grade hydrogen peroxide produced by the reverse osmosis process in the step (2) is reused after adjusting the concentration of byproducts by adding high purity water.

Preferably, the device is rinsed with high purity water before production and the hi purity water is replaced by the 50 wt %˜70 wt % hydrogen peroxide.

Preferably, a membrane of the reverse osmosis in the reverse osmosis device adopts one or more of aromatic polyamide membrane, polyamide piperazine membrane, polysulfone membrane, and polyvinyl chloride membrane.

The beneficial effects of the above-mentioned preferred technical solution are as follows. The permeability of the several kinds of membranes to hydrogen peroxide molecules and water molecules should be approximately the same, without changing the concentration of hydrogen peroxide; and the membrane itself has strong, anti-oxidation ability to prevent the membrane from being damaged by hydrogen peroxide and even dissolving in the hydrogen peroxide solution to bring new impurities to the product.

Preferably, a membrane of the ion exchange adopts a strong acidic cation exchange resin or a strong basic anion exchange resin of a copolymer of styrene and divinylbenzene containing sulfonic acid groups.

The beneficial effects of the above-mentioned preferred technical solution are as follows. Strongly acidic cation exchange resin can remove metal ions. Strongly basic anion exchange resin can remove acid radical ions. Chelating resin can remove iron ions and chloride ions, etc. At the operating temperature of 5-10° C., the anion exchange resin bed in series with cation the exchange resin beds can meet the requirements, of MOS products. Higher products require a series of chelating resin beds.

Preferably, a membrane of the ultrapure filtration adopts one or more of polytetrafluoroethylene membrane, polyvinylidene fluoride membrane, and PFA membrane.

Through the above technical solutions, compared with the prior art, the disclosure provides a production device and production method of electronic grade hydrogen peroxide aqueous solution integrating a variety of high-efficiency devices for continuous production. At the same time, the concentration of byproduct industrial grade hydrogen peroxide can be adjusted in the reverse osmosis process. The concentration of can be adjusted by adding high purity water so that the industrial grade hydrogen peroxide can be reused to saves production costs. The production method of the present invention can achieve annual growth by adjusting the permeable membrane, ion exchange resin and filter membrane. It can produce 6000 tons of G4 grade hydrogen peroxide and 15000 tons of G1 grade hydrogen peroxide per year. At the same time, it can produce 1523 tons of byproduct industrial grade hydrogen peroxide per year, which greatly improves production efficiency and reduces costs. Moreover, the present invention is mainly used for the production of the electronic grade hydrogen peroxide. In the process of production, storage, and transportation, nitrogen is used to seal the finished electronic grade hydrogen peroxide. During the production process, oxygen produced by the decomposing hydrogen peroxide, and the sealing nitrogen are components of the atmosphere. Therefore, the present invention does not produce waste gas during the production process conforming to the environmental protection concept.

### BRIEF DESCRIPTION OF THE DRAWINGS

In order to explain the embodiments of the present invention or the technical solutions in the prior art more clearly, the following drawings that need to be used in the description of the embodiments or the prior art will briefly introduced. Obviously, the drawings in the following description are only embodiments of the present invention. For those of ordinary skill in the art, other drawings can be obtained based on the drawings disclosed without creative work.

FIG. 1 is a structural diagram of a production device of an electronic grade hydrogen peroxide aqueous solution of the present invention.

### DETAILED DESCRIPTION OF EMBODIMENTS

The technical solutions in the embodiments of the present invention will be clearly and completely described below in conjunction with the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

### Embodiment 1

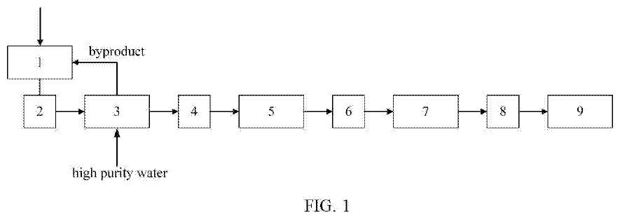

Referring to FIG. 1, a production device of an electronic grade hydrogen peroxide aqueous solution provided by the disclosure includes a rectification device 1, a first delivery pump 2, a reverse osmosis device 3, a second delivery pump 4, an ion exchange device 5, a third delivery pump 6, an ultrapure filter device 7, a fourth delivery pump 8 and a filling device 9 connected by pipelines sequentially.

The filling device 9 is a nitrogen sealing device. The rectification device 1, the reverse osmosis device 3, the ultrapure filter device 7 and the filling device 9 are lined with HDPE layer. The ion exchange device 5, the first delivery pump 2, the second delivery pump 4, the third delivery pump 6 and the fourth delivery pump 8 are lined with PFA layer.

A production method of the electronic grade hydrogen peroxide aqueous solution based on the above-mentioned production device is provided. The production method includes following steps.

(1) rectification: concentrating 27.5 wt % industrial grade hydrogen peroxide to 50 wt %˜70 wt % through rectification device;
(2) reverse osmosis: mixing the 50 wt %˜70 wt % hydrogen peroxide obtained in the step (1) with 50 wt % industrial grade hydrogen peroxide, pumping into the reverse osmosis device through the first delivery pump, and obtaining 31 wt % crude electronic grade hydrogen peroxide by reverse osmosis;
(3) ion exchange: transporting the 31 wt % crude electronic grade hydrogen peroxide obtained in step (2) to the ion exchange device through the second delivery pump, removing impurities through the ion exchange device and obtaining preliminary purified electronic grade hydrogen peroxide;
(4) ultrapure filtration: transporting the preliminary purified electronic grade hydrogen peroxide obtained in step (3) to the ultrapure filter device through the third delivery pump, obtaining 31 wt % electronic grade hydrogen peroxide by filtration, and transporting the 31 wt % electronic grade hydrogen peroxide to the filling device by the fourth delivery pump to store after filling.

In the step (2), the 50 wt %˜70 wt % industrial grade hydrogen peroxide produced by the reverse osmosis process in the step (2) is reused after adjusting the concentration of byproducts by adding high purity water.

The device is rinsed with high purity water before production and the high purity water is replaced by the 50 wt %˜70 wt % hydrogen peroxide.

A membrane of the reverse osmosis in the reverse osmosis device adopts one or more of aromatic polyamide membrane polyamide piperazine membrane, polysulfone membrane, and polyvinyl chloride membrane. A membrane of the ion exchange adopts a strong acidic cation exchange resin, or a strong basic anion exchange resin of a copolymer of styrene and divinylbenzene containing sulfonic acid groups. A membrane of the ultrapure filtration adopts one or more of polytetrafluoroethylene membrane, polyvinylidene fluoride membrane, and PFA membrane.

During the preparation process, G1 or G4 products are obtained by changing the reverse osmosis membrane material, the number of serial beds layers of the ion exchange resin bed and the type of the ion exchange resin.

The various embodiments in this specification are described in a progressive manner. Each embodiment focuses on the differences from other embodiments, and the same or similar parts among the various embodiments can be referred to each other. For the device disclosed in the embodiment, since it corresponds to the method disclosed in the embodiment, the description is relatively simple, and the relevant part can be referred to the description of the method part.

The above description of the disclosed embodiments enables those skilled in the art to implement or use the present invention. Various modifications to these embodiments will be obvious to those skilled in the art, and the general principles defined herein can be implemented in other embodiments without departing from the spirit or scope of the present invention. Therefore, the present invention will not be limited to the embodiments shown in, this document, but should conform to the widest scope consistent with the principles and novel features disclosed in this document.

1. A production device of an electronic grade hydrogen peroxide aqueous solution, comprising: a rectification device, a first delivery pump, a reverse osmosis device, a second delivery pump, an ion exchange device, a third delivery pump, an ultrapure filter device, a fourth delivery pump and a filling device connected by pipelines sequentially.

2. The production device of claim 1, wherein the filling device is a nitrogen sealing device.

3. The production device of claim 1, wherein the rectification device the reverse osmosis device, the ultrapure filter device and the filling device are lined with an HDPE layer.

4. The production device of claim 1, wherein the ion exchange device, the first delivery pump, the second delivery pump, the third delivery pump and the fourth delivery pump are lined with an PFA layer.

5. A method of producing the electronic grade hydrogen peroxide aqueous solution, comprising:
(1) rectification: concentrating 27.5 wt % industrial grade hydrogen peroxide to 50 wt %˜70 wt % through rectification device;
(2) reverse osmosis: mixing the 50 wt %˜70 wt % hydrogen peroxide obtained in the step (1) with 50 wt % industrial grade hydrogen peroxide, pumping the mixed hydrogen peroxide into the reverse osmosis device through the first, delivery pump, and obtaining 31 wt % crude electronic grade hydrogen peroxide by reverse osmosis;
(3) ion exchange: transporting the 31 wt % crude electronic grade hydrogen peroxide obtained in step (2) to the ion exchange device through the second delivery pump, removing some impurities through the ion exchange device and obtaining preliminary purified electronic grade hydrogen peroxide;
(4) ultrapure filtration: transporting the preliminary purified electronic grade hydrogen peroxide obtained in step (3) to the ultrapure filter device through the third delivery pump, obtaining 31 wt % electronic grade hydrogen peroxide by filtration, and transporting the 31 wt % electronic grade hydrogen peroxide to the filling device by the fourth delivery pump to store after filling.

6. The production method of claim 5, wherein the 50 wt %˜70 wt % industrial grade hydrogen peroxide produced by the reverse osmosis process in the step (2) is reused after adjusting the concentration of byproducts by adding high purity water.

7. The production method of claim 5, wherein the device is rinsed with high purity water before production and the high purity water is replaced by the 50 wt %˜70 wt % hydrogen peroxide.

8. The production method of claim 5, wherein a membrane of the reverse osmosis in the reverse osmosis device is one or more of aromatic polyamide membrane, polyamide piperazine membrane, polysulfone membrane, and polyvinyl chloride membrane.

9. The production method of claim 5, wherein a membrane of the ion exchange is a strong acidic cation exchange resin or a strong basic anion exchange resin of a copolymer of styrene and divinylbenzene containing sulfonic acid groups.

10. The production, method of claim 5, wherein a membrane of the ultrapure filtration is one or more of polytetrafluoroethylene membrane, polyvinylidene fluoride membrane, and PFA membrane.
